(19) United States
(12) Patent Application Publication
(10) Pub. No.: US 2025/0356209 A1
(43) Pub. Date: Nov. 20, 2025

(54) DISTILLING DIFFUSION MODELS USING IMITATION LEARNING

(71) Applicant: QUALCOMM Incorporated, San Diego, CA (US)

(72) Inventors: Risheek GARREPALLI, San Diego, CA (US); Shweta MAHAJAN, San Diego, CA (US); Munawar HAYAT, San Diego, CA (US); Fatih Murat PORIKLI, San Diego, CA (US)

(21) Appl. No.: 18/830,210

(22) Filed: Sep. 10, 2024

Related U.S. Application Data
(60) Provisional application No. 63/647,609, filed on May 14, 2024.

(51) Int. Cl. G06N 3/096; G06N 3/045; G06V 10/774

(52) U.S. Cl. CPC G06N 3/096; G06N 3/045; G06V 10/774

(57) ABSTRACT

Certain aspects of the present disclosure provide techniques and apparatus for improved machine learning. In an example method, a first set of one or more processed images is generated based on processing one or more images for a first time interval using a student machine learning model. It is determined whether a condition with respect to the first set of one or more processed images is satisfied, and a second set of one or more processed images is generated based on processing one or more images for a second time interval using an expert machine learning model based at least in part on determining that the condition is satisfied.

### CROSS-REFERENCE TO RELATED APPLICATION(S)

The present application for patent claims the benefit of priority to U.S. Provisional Appl. No. 63/647,609, filed May 14, 2024, which is hereby incorporated by reference herein in its entirety.

### INTRODUCTION

Aspects of the present disclosure relate to machine learning.

A wide variety of machine learning model architectures have been trained to perform an assortment of diverse tasks, including computer vision tasks, language tasks, classification and regression tasks, and the like. Recently, research has yielded substantial success in using large language models (LLMs), large vison models (LVMs), latent diffusion models (LDMs), and the like to process and generate output data. Often, machine learning models (especially LLMs, LVMs, and LDMs) have many parameters (e.g., millions or even billions), resulting in significant model size, as well as substantial computational expense in both training the model and using the model for generating output during runtime.

For example, diffusion models generally rely on performing a relatively large number of iterations or passes to iteratively generate output data (e.g., images, video, audio, text, and the like). Though this generative sampling can result in impressive output, the lengthy process significantly limits its practicality (particularly for computing devices with limited computational and/or power resources, such as smartphones).

### BRIEF SUMMARY

Certain aspects of the present disclosure provide a processor-implemented method, comprising: generating a first set of one or more processed images based on processing one or more images for a first time interval using a student machine learning model; determining whether a condition with respect to the first set of one or more processed images is satisfied; and generating a second set of one or more processed images based on processing one or more images for a second time interval using an expert machine learning model based at least in part on determining that the condition is satisfied.

Certain aspects of the present disclosure provide a processor-implemented method, comprising: accessing a first diffusion model; generating a first set of trajectories using the first diffusion model; obtaining an output of a trained second diffusion model based on the first set of trajectories; generating a second set of trajectories based on: selecting, for each time step of a plurality of time steps, either the first diffusion model or the second diffusion model; generating an output using the selected model; and updating the second set of trajectories based on the output; generating a third set of trajectories based on the second set of trajectories and using the first diffusion model; and obtaining an output of the trained second diffusion model based on the third set of trajectories.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example workflow for generating distilled diffusion models, according to some aspects of the present disclosure.

FIG. 2 depicts an example workflow for distilling diffusion models, according to some aspects of the present disclosure.

FIG. 3 depicts an example timeline for generating output using diffusion models, according to some aspects of the present disclosure.

FIG. 4 is a flow diagram depicting an example method for generating improved trajectories for training machine learning models using step distillation, according to some aspects of the present disclosure.

FIG. 5 is a flow diagram depicting an example method for improved training of machine learning models using step distillation, according to some aspects of the present disclosure.

FIG. 6 is a flow diagram depicting an example method for generating output using diffusion models, according to some aspects of the present disclosure.

FIG. 7 is a flow diagram depicting an example method for diffusion machine learning, according to some aspects of the present disclosure.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning.

Many generative models, such as diffusion models, excel at generative sampling (e.g., text-to-image generation) but rely on many network passes for sampling at inference, limiting practicality. Some efforts have been made to reduce the computational resources used during output generation (e.g., to reduce the number of iterations or passes that are performed). One such approach includes step distillation (e.g., progressive distillation), which seeks to train a model to generate output using fewer iterations as compared to conventional diffusion models. For example, a conventional diffusion model (relying on many iterations) may be used to train a “distilled” model that uses fewer iterations to generate output (e.g., learning to perform a single iteration for every two iterations of the initial model). However, such approaches often result in sub-optimal performance. For example, some conventional approaches to progressive distillation result in outputs (e.g., images) that are substantially worse than those generated by a conventional diffusion model (e.g., where the image subjects may be unrecognizable or at least less defined).

In some aspects, covariate shift may be at least partially responsible for the poor performance of some conventional step distillation approaches. Covariate shift generally refers to when the distribution of the input features to a model differ from the distribution observed during training of the model. In some conventional solutions, a discrepancy between the training and inferencing for distilled models can lead to compounding error across iterations (unlike continuous time diffusion models).

In some aspects of the present disclosure, covariate shift can be reduced or eliminated using a step distillation approach within an imitation learning framework. In some aspects, an interactive-learning-based framework using dataset aggregation is used, which can demonstrate substantially improved generative performance. In some aspects, using techniques and architectures described herein, the output diversity and coverage of distilled models can be improved as compared to some conventional distillation techniques. For example, many conventional distillation techniques rely on changing the underlying map(s) from the prior to the output data space, which may be an undesirable behavior resulting in reduced generative diversity. Using aspects of the present disclosure, advantageously, the underlying map may be preserved, retaining coverage and demonstrating high quality output using fewer iterations.

In some aspects, the diffusion process (also referred to in some aspects as a denoising process) can be cast as a finite horizon Markov decision process (MDP) defined by a set of states (e.g., the denoised latent at a given step or iteration), a set of actions (e.g., operations or transformations to transform the current state to a new state), and a set of transition dynamics (e.g., indicating how actions are applied). As used herein, a “trajectory” refers to a sequence of state-action pairs (e.g., beginning with noise and ending with a model output, such as an image).

In some aspects of the present disclosure, a policy or student model (e.g., a distilled machine learning model) can be trained to mimic an expert model (referred to in some aspects as a teacher model) based on a set of trajectories induced by an expert policy (e.g., the original non-distilled generative model). After this initial training, trajectory sampling may be performed by choosing either the student model or the expert model for each state transition (e.g., in a stochastic manner) to generate a set of trajectories. These trajectories and corresponding states (e.g., latents zₜ in the case of diffusion) can be added to a training dataset. In some aspects, expert feedback along these trajectories can then be obtained (e.g., by processing the trajectories using the expert model). This results in the generation of new training data for the student.

In some aspects, the initial training of the student model may begin with the student model training based on the induced distributions of the expert model. As training progresses, the system may sample more along the student distribution, allowing the system to train and/or distill the student model on both expert-induced distributions and student-induced distributions. This joint or hybrid distillation can significantly improve output generation of the student model. For example, training on both expert- and student-induced distributions can reduce covariate shift, preserve the underlying mappings (leading to the term “map-preserving distillation”), and generally teach the student model to perform relevant corrections during generation iterations, aligning the output more closely to the output of the expert model during runtime use.

Advantageously, aspects of the present disclosure can provide gradient field preserving distillation (which may be particularly beneficial for techniques involving inversion, low-rank adaptation (LoRA), and the like, as well as improving model compositionality). Further, aspects of the present disclosure can enable faster convergence during training (e.g., relying on fewer gradient updates), as well as faster inference after training (e.g., due to the reduced number of diffusion steps). Additionally, aspects of the present disclosure provide enhanced training stability, as well as enabling low and/or constant memory use (e.g., GPU memory) during training and inference.

In some aspects, training of the machine learning model(s) may be performed on-device (e.g., on a resource-constrained device such as a smartphone, laptop, or other edge device) or off-device (e.g., on a server, in the cloud, and the like). In some aspects, initial training of the distilled machine learning model can be performed by system(s) such as a server or cloud-based application, and the distilled model can then be provided to edge device(s) for inference. In some aspects, such edge devices may further refine or fine-tune the distilled models on-device. For example, in some aspects, edge devices (such as smartphones) may perform on-device learning on the distilled model using adapters (e.g., LoRA adapters) and/or may finetune the distilled model for particular use case(s). In some aspects, the distillation techniques described herein can facilitate improved on-device learning (as compared to some conventional approaches) due to the way the distilled model is formulated. For example, the distilled model(s) may be trained more accurately, using fewer resources and/or samples, and/or in less time.

In some aspects, after training, the student model may be used to generate output inferences or predictions (e.g., to generate images or other data). Due to the training techniques discussed in more detail below, these student models may perform more accurately (e.g., generating higher quality output) with reduced computational expense, as compared to some conventional approaches. In some aspects, the student model and expert model may both be used for data generation at runtime. For example, in some aspects, the student model may be used to generate a first output for a given time interval or step (e.g., a first diffusion step), and the machine learning system may determine whether to use the student model or the expert model for the subsequent diffusion step (e.g., whether to process the first output using the student model again, or to use the expert model for the next step).

In some aspects, the system can determine which model to use for each diffusion step based on a variety of criteria, such as relating to the condition of the current model output (e.g., the state of the current processed or generated image that was generated during the most recent iteration). For example, if the output does not satisfy one or more quality thresholds (e.g., the output quality is insufficient for the current iteration, such as because the output is not sufficiently similar to output the expert model produced previously or would have produced for the current step), the system may determine to use the expert model for the next iteration(s). As another example, in some aspects, the system may select between the expert and student models randomly (or with at least an element of randomness). For example, the system may use a biased stochastic operation (biased towards either the student or the expert) for each iteration, where the bias may shift across iterations (e.g., biased more towards the student or expert for later iterations, as compared to early iterations).

### Example Workflow for Generating Distilled Diffusion Models

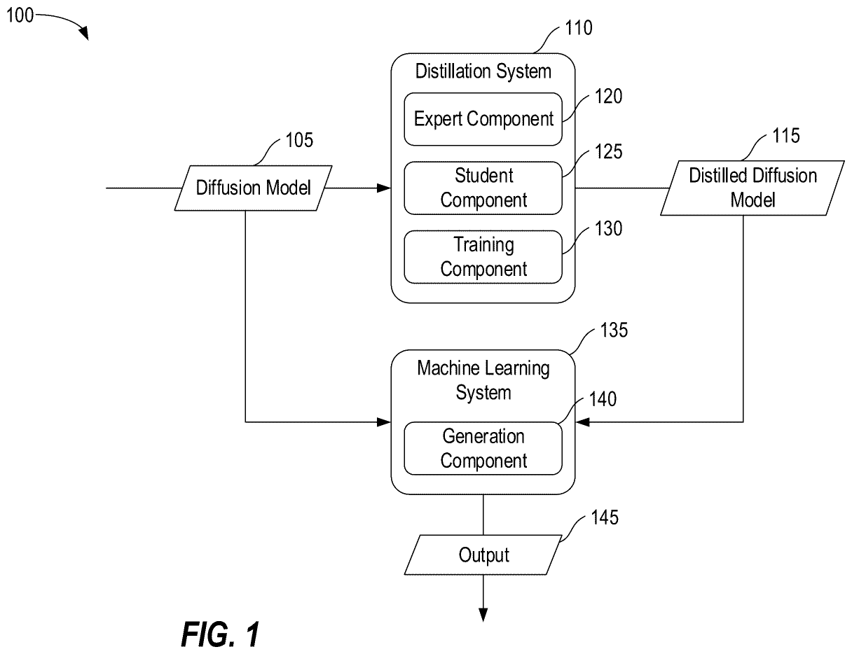

FIG. 1 depicts an example workflow 100 for generating distilled diffusion models, according to some aspects of the present disclosure. The illustrated example includes a distillation system 110 and a machine learning system 135. Although depicted as discrete systems for conceptual clarity, in some aspects, some or all of the operations of the distillation system 110 and the machine learning system 135 may be combined or distributed across any number of systems. Generally, the distillation system 110 and the machine learning system 135 are representative of any computing system(s) capable of performing the operations discussed below, and may be implemented using hardware, software or a combination of hardware and software.

In the illustrated example, the distillation system 110 accesses a diffusion model 105. As used herein, “accessing” data may generally include receiving, requesting, retrieving, obtaining, collecting, generating, or otherwise gaining access to the data. For example, the distillation system 110 may receive the diffusion model 105 from a separate system (e.g., a dedicated training system), or may itself train the diffusion model 105. As discussed above, the diffusion model 105 is generally representative of a machine learning model that uses a sequence of iterations or steps (referred to in some aspects as time intervals) to iteratively generate output data (e.g., images), such as via a learned denoising process (e.g., conditioned based on textual input). For example, the diffusion model 105 may represent an LDM. In some aspects, the diffusion model 105 may begin with a (random) noisy latent, and iteratively denoised the latent based on previous training (resulting in one or more denoised latents, referred to in some aspects as processed output and/or processed images, during each iteration). In some aspects, this diffusion process is guided via input conditioning (e.g., based on an input prompt, such as a text string or an image, indicating characteristics of the desired output).

In the illustrated example, the distillation system 110 comprises an expert component 120, a student component 125, and a training component 130. Generally, the operations of the depicted components (and others not illustrated) may be combined or distributed across any number of components. In some aspects, the expert component 120 is used to generate output (e.g., processed images) using the diffusion model 105 (referred to in some aspects as the expert machine learning model). For example, at one or more time intervals (e.g., one or more steps or iterations of the diffusion process), the expert component 120 may use the diffusion model 105 to generate a next intermediate output (e.g., a next processed image) based on the previously generated intermediate output (e.g., the processed image generated during the prior step).

In some aspects, the student component 125 is used to generate output (e.g., processed images) using a student diffusion model (e.g., the distilled diffusion model 115). For example, at one or more time intervals (e.g., one or more steps or iterations of the diffusion process), the student component 125 may use the distilled diffusion model 115 to generate a next intermediate output (e.g., a next processed image) based on the previously generated intermediate output (e.g., the processed image generated during the prior step). In some aspects, the parameters of the distilled diffusion model 115 may be loaded or instantiated from the parameters of the (expert) diffusion model 105. For example, during initialization of the student model, the student component 125 may copy the parameters of the diffusion model 105 for some or all of the components of the distilled diffusion model 115. These parameters may then be updated during training. In another example, subsequent to initialization and/or at least some training of the distilled diffusion model 115, the student component 125 may load some or all of the parameters of the (expert) diffusion model 105 to the distilled diffusion model 115.

In the illustrated example, the training component 130 may be used to refine or update the parameters of the student model (e.g., the distilled diffusion model 115), such as using step distillation, as discussed above. For example, the diffusion model 105 may be configured to generate output using a first number of iterations, while the distilled diffusion model 115 may be trained to generate the same (or similar) output using fewer iterations.

In some aspects, as discussed in more detail below, the training component 130 may train the distilled diffusion model 115 based on hybrid trajectories comprising samples from both the diffusion model 105 and the distilled diffusion model 115. For example, as discussed below, the training component 130 may randomly or pseudo-randomly (e.g., using biased stochastic selection) select between the diffusion model 105 and the distilled diffusion model 115 to perform a “next” iteration in a generation trajectory. This trajectory may then be used as a new input sequence to further train the distilled diffusion model 115 (e.g., using labels generated at each step by the expert diffusion model 105), allowing the distilled diffusion model 115 to learn to better follow the diffusion model 105 (while using fewer generation iterations).

In the illustrated example, the machine learning system 135 can then access the (expert) diffusion model 105 and the trained (student) distilled diffusion model 115 after training. As illustrated, the machine learning system 135 can use the diffusion model 105 and/or the distilled diffusion model 115 to generate output 145 (e.g., images), as discussed in more detail below. For example, the machine learning system 135 may, at each iteration or time interval, determine whether to process the current output (e.g., the processed image(s) generated during the prior iteration) using the diffusion model 105 or the distilled diffusion model 115. After a number of such iterations are complete, the output 145 can be provided (e.g., output to a user or other entity that requested the output be generated).

### Example Workflow for Distilling Diffusion Models

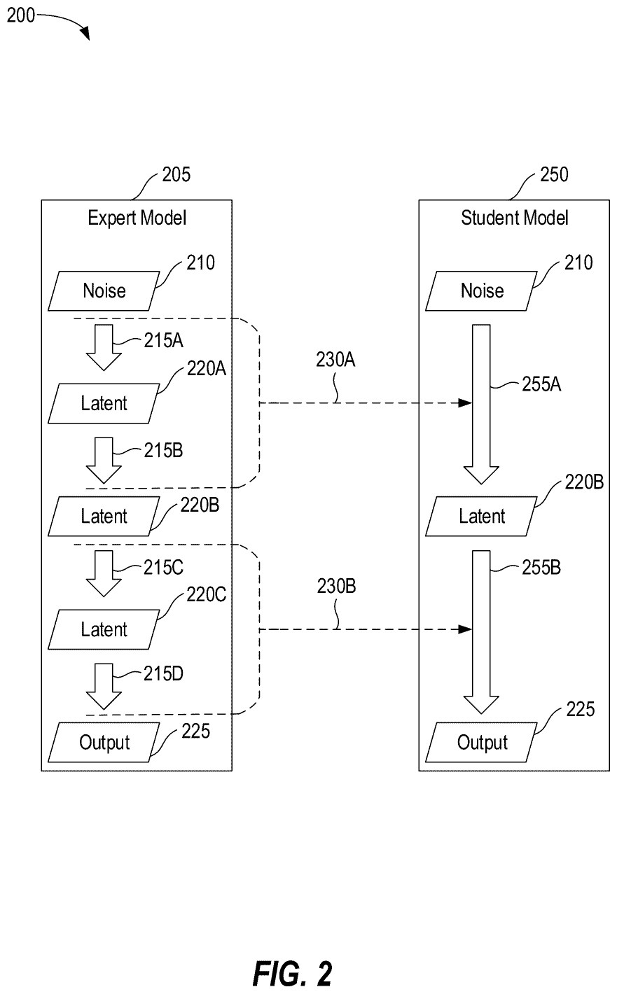

FIG. 2 depicts an example workflow 200 for distilling diffusion models, according to some aspects of the present disclosure. In some aspects, the workflow 200 is performed by a distillation system, such as the distillation system 110 of FIG. 1.

As illustrated, an expert model 205 (e.g., the diffusion model 105 of FIG. 1) can perform a sequence of operations 215 (also referred to as iterations, as discussed above) to generate an output 225 based on initial noise 210. Specifically, as discussed above, the expert model 205 may iteratively process the input to denoised the data. For example, each operation 215A-D may correspond to application of the expert model 205 (e.g., a denoising operation of the model). In some aspects, these operations 215 are performed based on prior training of the expert model 205.

In the illustrated example, the initial noise 210 may generally correspond to any input, including random noise (e.g., Gaussian noise). In the illustrated example, after a first iteration of the operation 215A, the expert model 205 generates a latent 220A (e.g., a latent tensor). In some aspects, the latent 220A may be referred to as a denoised latent or tensor, or a processed latent. For example, in some aspects, if the output 225 comprises one or more images, the latent 220A may be referred to as one or more “processed images” to indicate that the noise 210 has been processed using at least one iteration of the model.

As illustrated, this latent 220A (e.g., the first processed image) can then be processed using a second operation 215B (e.g., a second iteration of the expert model 205) to generate a second latent 220B (e.g., a second processed image). As above, this latent 220B can then be processed using a third iteration of the expert model 205 (e.g., depicted as operation 215C) to generate a fourth latent 220C, which can be processed using a fourth iteration of the expert model 205 (depicted as operation 215D) to generate the output 225 (e.g., the output processed image). That is, in the illustrated example, the expert model 205 uses a sequence of four iterations to generate output 225.

As illustrated, a student model 250 (e.g., the distilled diffusion model 115 of FIG. 1) may similarly process noise 210 (e.g., random noise) over one or more iterations to generate output 225. However, as illustrated, the student model 250 has learned (during training) to generate the output 225 using fewer iterations. Specifically, as indicated by the arrow 230A, the operations 215A and 215B (e.g., the first two iterations of the expert model 205) have been distilled into a single application of the student model 250 (e.g., the operation 255A). That is, the student model 250 may directly generate the latent 220B using a single operation 255A, rather than using two operations 215A and 215B.

Further, as illustrated by the arrow 230B, the operations 215C and 215D (e.g., the final two iterations of the expert model 205) have been distilled into a single application of the student model 250 (e.g., the operation 255B). That is, the student model 250 may directly generate the output 225 based on the latent 220B using a single operation 255B, rather than using two operations 215C and 215D. In this way, the student model 250 may generate output using substantially fewer computational resources, as compared to the expert model 205.

Although the illustrated example depicts a 2:1 distillation (e.g., where each iteration or time interval of the student model 250 corresponds to two iterations or time intervals of the expert model 205), various distillation ratios may be used depending on the particular implementation. For example, the student model 250 may generally be trained to perform N steps to match M steps of the expert model 205 (where N<M).

In some aspects, as discussed below in more detail, the distillation training represented by the arrows 230A and 230B may be performed using hybrid trajectory sampling of the expert model 205 and the student model 250. For example, the distillation system may sample either the expert model 205 or the student model 250 at each iteration of a given trajectory (where a trajectory begins with noise 210 and ends with an output 225), such as using a random (or pseudo-random) selection. These hybrid trajectories (each including both expert decisions or output from the expert model 205, as well as student decisions from the student model 250) may then be labeled using the expert model 205 (e.g., where the state or processed image at a given step in the trajectory is processed using the expert model 205 to generate a next state or image). In this way, at each step of each trajectory, the distillation system can teach the student model 250 to respond in a similar manner to how the expert model 205 would respond (e.g., based on the generated label for the given step of the trajectory). This causes the output of the student model 250 to more closely resemble the output of the expert model 205 while using fewer iterations (e.g., fewer operations 255).

### Example Method for Generating Output Using Diffusion Models

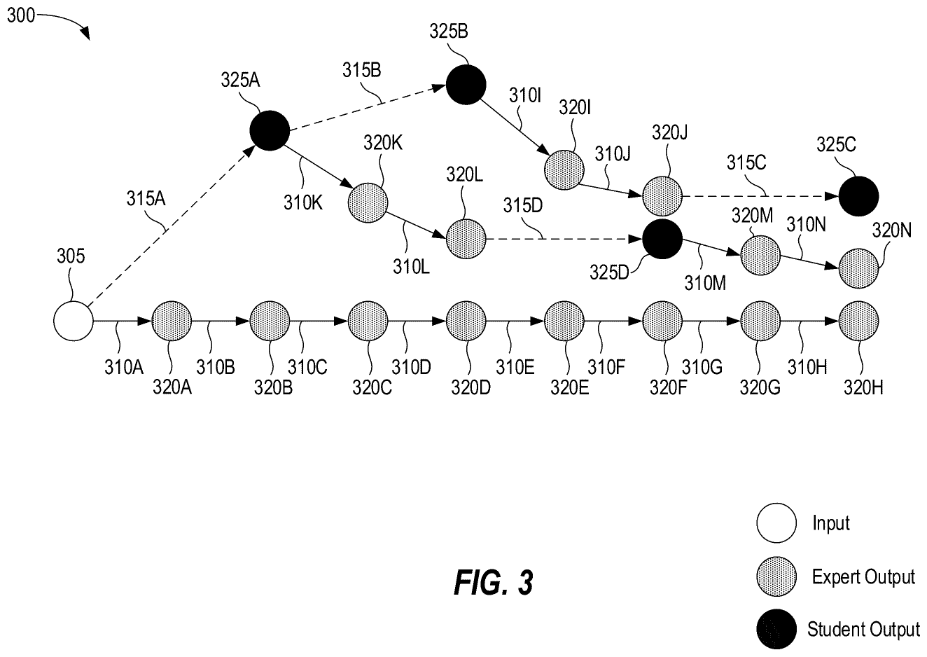

FIG. 3 depicts an example timeline 300 for generating output using diffusion models, according to some aspects of the present disclosure. Specifically, the timeline 300 depicts various potential trajectories of data generation based on sampling between an expert model (e.g., the diffusion model 105 of FIG. 1 and/or the expert model 205 of FIG. 2) and a student model (e.g., the distilled diffusion model 115 of FIG. 1 and/or the student model 250 of FIG. 2).

In the illustrated example, each trajectory may begin with noise at a first step 305 (also referred to as a first iteration and/or a first time interval, as discussed above). In the illustrated example, solid arrows 310 indicate application of the expert model at the given iteration, while dashed arrows 315 indicate application of the student model at the given iteration. Further, intermediate output 320 having stippling indicates the output of the expert model at the given step, while intermediate output 325 with a solid background indicates the output of the student model at the given step. In some aspects, as discussed above, each intermediate output 320 and 325 may be referred to as denoised data, a processed image, and the like.

In the illustrated example, a first application of the expert model may be applied at arrow 310A to generate an intermediate output 320A based on the initial noise. This intermediate output 320A can then be processed using a second application of the expert model (at arrow 310B) to generate a second intermediate output 320B. Further, as illustrated, an intermediate output 325A may be generated by processing the initial noise using a single iteration of the student model (as indicated by the arrow 315A). That is, as illustrated, application of the student model (represented by the arrow 315A) may represent two applications of the expert model (represented by the arrows 310A and 310B), as the intermediate outputs 325A and 320B are aligned. However, as indicated by the vertical displacement, the intermediate output 325A of the student model differs at least somewhat from the equivalent or corresponding intermediate output 320B of the expert model at this time interval.

In some aspects, as discussed above, the distillation system may determine which model to use for a given time interval using a biased stochastic operation. For example, suppose the expert model is used at each step. As illustrated, the intermediate output 320B is processed using the expert model (indicated by the arrow 310C) to generate an intermediate output 320C, the intermediate output 320C is processed using the expert model (indicated by the arrow 310D) to generate an intermediate output 320D, the intermediate output 320E is processed using the expert model (indicated by the arrow 310E) to generate an intermediate output 320E, the intermediate output 320E is processed using the expert model (indicated by the arrow 310F) to generate an intermediate output 320F, the intermediate output 320F is processed using the expert model (indicated by the arrow 310G) to generate an intermediate output 320G, and the intermediate output 320G is processed using the expert model (indicated by the arrow 310H) to generate an intermediate output 320H. This intermediate output 320H may be the actual or final output of the expert model.

Returning to the intermediate output 325A (generated after one iteration of the student model), the intermediate output 325 can determine whether to continue the trajectory using the student model for the next interval (as indicated by the arrow 315B to generate the intermediate output 325B), or the expert model for the next interval(s) (as indicated by the arrows 310K and 310L to generate the intermediate outputs 320K and 320L, respectively). As illustrated, the intermediate output 320L may be more similar to the original output of the expert model, as compared to the intermediate output 325B of the student model. That is, after the student model has begun to diverge from the trajectory of the expert (as indicated by the vertical displacement of the intermediate output 325A relative to the expert baseline at intermediate output 320B), the expert model may begin to direct the outputs back towards the expert trajectory. In some aspects, as discussed above, using this hybrid sampling technique to generate training trajectories (where the “next step” label is provided by the expert model) can allow the student model to learn more dynamically about how to respond to proceed at any given iteration, as compared to being trained based solely on student trajectories and/or based solely on expert trajectories.

As illustrated, after generating the intermediate output 320L using the expert model, the student model may be used (indicated by the arrow 315D) to generate a next intermediate output 325D. The expert model may then be used (as indicated by the arrow 310M) to generate the intermediate output 320M, and a final iteration of the expert model may be used (as indicated by the arrow 310N) to generate the intermediate output 320N (e.g., the output of the hybrid trajectory).

Similarly, after generation of the intermediate output 325B using the student model, the expert model may be used (as indicated by the arrow 310I) to generate the intermediate output 320I, which may be processed again by the expert model (indicated by the arrow 310J) to generate the intermediate output 320J. This intermediate output 320J may then be processed using the student model (indicated by the arrow 315C) to generate the intermediate output 325C (e.g., the output of this hybrid trajectory).

Generally, at each iteration or time interval, the distillation system may select either the student or the teacher to perform the next step. This can allow the distillation system to generate a variety of hybrid trajectories that each include student and expert decisions, substantially increasing the diversity of the training data and improving the training of the student model, as discussed in more detail below.

### Example Method for Generating Improved Trajectories for Training Machine Learning Models Using Step Distillation

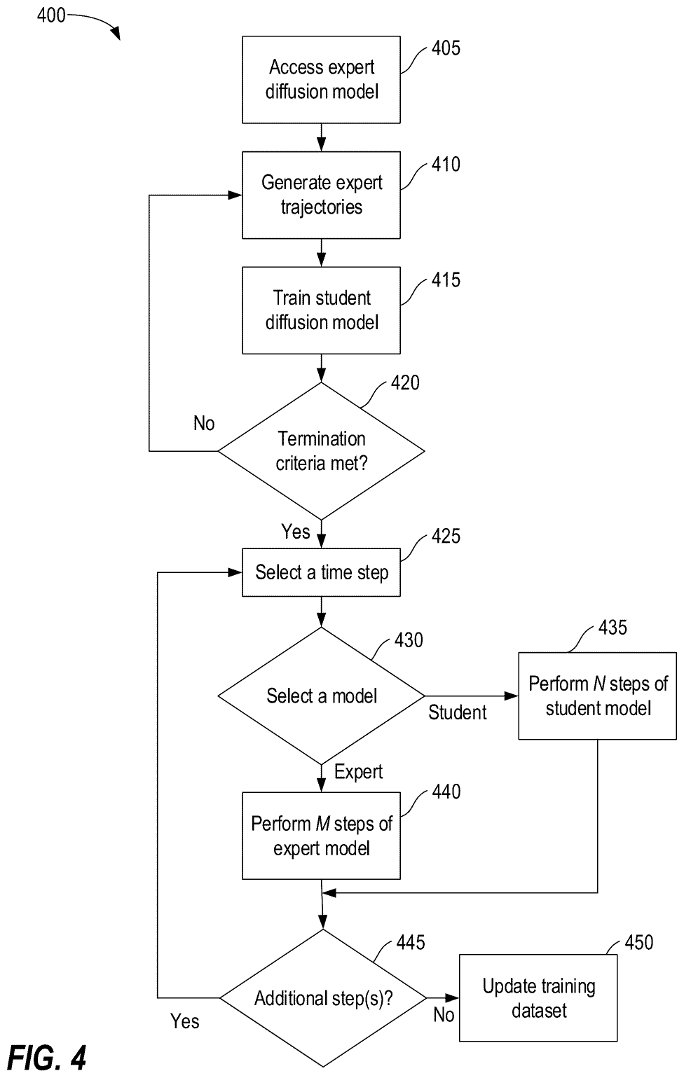

FIG. 4 is a flow diagram depicting an example method 400 for generating improved trajectories for training machine learning models using step distillation, according to some aspects of the present disclosure. In some aspects, the method 400 is performed by a distillation system, such as the distillation system 110 of FIG. 1.

At block 405, the distillation system accesses an expert diffusion model (referred to as the teacher model in some aspects). For example, the expert diffusion model may correspond to the diffusion model 105 of FIG. 1 and/or the expert model 205 of FIG. 2. As discussed above, this expert diffusion model generally corresponds to a generative machine learning model (e.g., an LDM). In some aspects, the expert diffusion model generally uses a relatively larger number of iterations to generate output, as compared to the student model (discussed in more detail below). Generally, diffusion models operate by iteratively denoising data in a latent space (e.g., beginning with a noisy latent and ending with a fully denoised latent that can be converted to an image). In some aspects, the denoising process is guided based on input (e.g., text input) indicating the desired output. For example, a user may provide natural language text such as “a hippopotamus in space” to cause the expert model to generate an image of a hippopotamus in space.

At block 410, the distillation system generates a set of expert trajectories using the expert diffusion model. In some aspects, as discussed above, these expert trajectories generally correspond to generating a set of outputs using the expert diffusion model while monitoring the iterative process (e.g., the latent tensor at each step or iteration). That is, the distillation system may track the intermediate data generated by the expert model (e.g., the processed images, such as the latents 220A-C of FIG. 2 and/or the intermediate outputs 320 of FIG. 3, at each time interval). For example, the distillation system may input contextual or prompt information used to guide the process (e.g., natural language text) and record, at each iteration, the current version of the noisy latent (e.g., the current processed image). As discussed above, in some aspects, each trajectory corresponds to a sequence of states (e.g., the sequence of latent tensors or processed images) and/or an associated set of actions (e.g., the operations or transformations applied to transition between states in the sequence). By generating a set of expert trajectories (e.g., using any number of inputs or guidance), the distillation system can effectively capture the mappings used by the expert model.

At block 415, the distillation system trains a student diffusion model (e.g., the distilled diffusion model 115 of FIG. 1 and/or the student model 250 of FIG. 2) based on the set of expert trajectories. In some aspects, the distillation system uses step distillation to train the student model. As discussed above, step distillation generally involves distilling M iterations of the expert model into N iterations of the student model, where M>N. For example, the distillation system may train the student model to perform one iteration for every two iterations of the expert model. In some aspects, the distillation system trains the student model by, for each iteration, providing supervision corresponding to two (or more) iterations of the expert model. For example, suppose a given expert trajectory includes a sequence of zₜ₋₂, zₜ₋₁, and zₜ. This indicates that the expert model generated zₜ₋₁ based on zₜ₋₂ (during a first iteration) and then generated zₜ based on zₜ₋₁ (during a second iteration). In some aspects, at block 415, the distillation system trains the student model to generate zₜ based directly on zₜ₋₂ in a single iteration.

Generally, block 415 includes training the student model on any number of expert trajectories. This distillation process teaches the student model to generate model output that is similar to the expert model in fewer iterations or steps. However, as discussed above, the student model may perform poorly when the model input (e.g., the text string) differs from those used during training. For example, the student may have learned to closely follow the teacher model's mappings, but may struggle to operate effectively when the latents begin to differ from those reflected in the expert trajectories.

At block 420, the distillation system determines whether one or more termination criteria are met. The particular termination criteria used may vary depending on the particular implementation, and may include, for example, determining whether additional expert trajectories remain to be used to train the student, determining whether a defined number of training cycles, computational resources, or length of time has been spent training the student, and the like. If the criteria are not met, the method 400 returns to block 410.

If, at block 420, the distillation system determines that the criteria are met, the method 400 continues to block 425. At block 425, the distillation system selects a time step. That is, the distillation system determines the current generation time step or iteration number. For example, the distillation system may first determine that the process is at the first iteration (e.g., beginning with a noisy input). Subsequently, the distillation system may progressively move through the iterations until the model output is created. In some aspects, at the start of each generation sequence (e.g., the first iteration of a sequence of iterations), the distillation system may select a guidance input (e.g., a text string) to use for the generation sequence. This guidance information may be the same guidance used to generate the expert trajectories, or may differ.

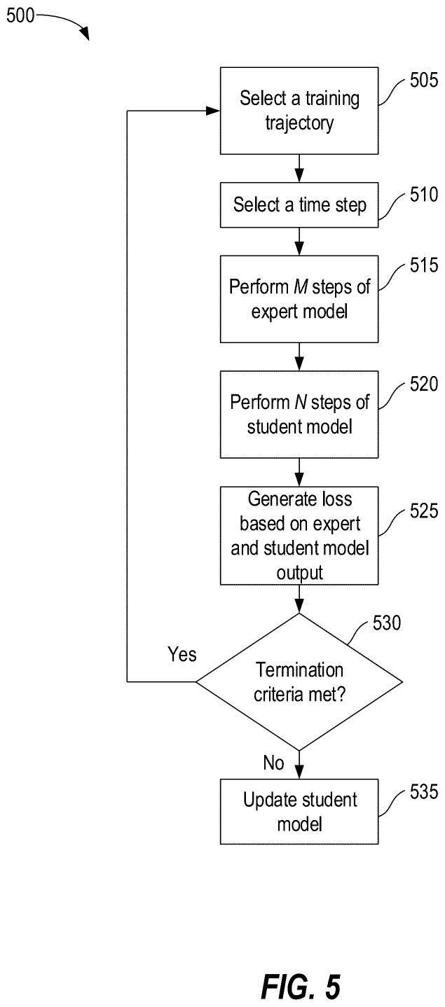

At block 430, the distillation system selects a model (e.g., either the student model or the expert model) to perform the current (selected) time step or iteration. For example, in some aspects, the distillation system selects the model stochastically (e.g., using at least an element of randomness). In some aspects, the distillation system may initially bias the selection towards the expert model (e.g., selecting the expert model more frequently than selecting the student model). As training progresses (discussed in more detail below with reference to FIG. 5), the distillation system may bias the selection more towards the student model.

If the distillation system selects the student model at block 430, the method 400 continues to block 435, where the distillation system performs N steps of diffusion using the student model. For example, as discussed above, the distillation system may perform a single diffusion operation based on the current time step (selected at block 425) and the guidance selected for the current sequence (e.g., the text string embedding) using the student model. The method 400 then continues to block 445.

Returning to block 430, if the distillation system selects the expert model, the method 400 continues to block 440. At block 440, the distillation system performs M steps of diffusion using the expert model. For example, as discussed above, the distillation system may perform a two diffusion operations based on the current time step (selected at block 425) and the guidance selected for the current sequence (e.g., the text string embedding) using the expert model. In some aspects, as discussed above, M>N. That is, the expert model may perform more iterations, as compared to the student model, to reach the same output step. The method 400 then continues to block 445.

At block 445, the distillation system determines whether there is at least one additional step remaining in the trajectory generation process. For example, as discussed above, the expert model may be trained to generate output after some number of iterations (e.g., W iterations, such as W=30), while the student model is trained to generate output after X iterations (e.g., X=15). In some aspects, at block 445, the distillation system determines whether the target number of time steps have been completed (e.g., whether the time step selected at block 425 was the final time step in the sequence). If at least one additional iteration remains, the method 400 returns to block 425 to select the next time step (e.g., to increment the iteration counter by M if the teacher model was selected, and by N if the student model was selected).

If, at block 445, the distillation system determines that no additional steps remain in the current generation sequence, the method 400 continues to block 450, where the distillation system updates the training dataset to include the hybrid trajectory that was generated. In this way, the trajectory can include latents or intermediate outputs (e.g., processed images) generated by the student model as well as by the teacher model (selected stochastically). Although a single trajectory is depicted in the illustrated example, in some aspects, the method 400 may then return to block 425 to begin a new trajectory-generation process.

Once a sufficient or desired number of training trajectories (each include teacher input and student input) are generated, the method 400 may terminate, and the distillation system may begin training or refining the student model (e.g., using the method 500 of FIG. 5).

### Example Method for Improved Training of Machine Learning Models Using Step Distillation

FIG. 5 is a flow diagram depicting an example method 500 for improved training of machine learning models using step distillation, according to some aspects of the present disclosure. In some aspects, the method 500 is performed by a distillation system, such as the distillation system 110 of FIG. 1 and/or discussed above with reference to FIGS. 2-4.

At block 505, the distillation system selects a training trajectory (e.g., from the training dataset generated at block 450 of FIG. 4). Generally, the distillation system may select the training trajectory using any suitable criteria or technique (including randomly or pseudo-randomly).

At block 510, the distillation system can select at time step or interval of the selected trajectory. That is, in addition to selecting a trajectory, the distillation system may select a time step or iteration number within the trajectory (e.g., selecting which state, in the trajectory, to use for the current iteration of training).

At block 515, the distillation system performs M diffusion steps using the expert diffusion model based on the selected training trajectory (e.g., beginning at the selected state or latent in the trajectory). In this way, the distillation system can effectively obtain expert input or supervision (e.g., asking the expert model how to proceed given the selected state). This can allow the student model to learn to mimic the expert model more effectively (e.g., because the trajectory includes both student data as well as expert data). That is, the distillation system may allow the expert model to correct or guide the student more effectively, as compared to conventional solutions.

At block 520, the distillation system can similarly perform N diffusion steps using the student diffusion model based on the selected training trajectory (e.g., beginning at the selected state or latent in the trajectory). In this way, the distillation system can determine the student output for the given state. This can be compared against the expert output to teach the student model to better mimic the expert model (e.g., because the trajectory includes both student data as well as expert data). That is, the distillation system may allow the expert model to correct or guide the student more effectively, as compared to conventional solutions.

At block 525, the distillation system generates a loss based on the expert model output (e.g., the latent or other output generated by the expert model at block 515) and the student model output (e.g., the output generated by the student model at block 520) for the same input and time interval. In some aspects, this output of the expert model may be referred to as the target or ground truth (e.g., indicating that the student model should seek to generate the target output when the selected trajectory and state is used as input). For example, in some aspects, the distillation system may generate a loss between the expert output and the output of the student model (when given the same input from the same trajectory). That is, the loss may represent the difference between the expert's output and the student's output given for the same intermediate step of the same trajectory.

At block 530, the distillation system determines whether to perform at least one more iteration of obtaining expert feedback on the training trajectories. If so, the method 500 returns to block 505. Generally, the distillation system may evaluate a wide variety of criteria at block 520. For example, the distillation system may determine whether expert guidance has been obtained for each trajectory and/or for each step of each trajectory in the training dataset.

If, at block 530, the distillation system determines that the one or more termination criteria are satisfied (e.g., no training trajectories remain), the method 500 continues to block 535. At block 535, the distillation system updates the parameter(s) of the student model based on this augmented trajectory dataset (e.g., the training trajectories augmented with new targets corresponding to the expert model output). That is, the distillation system may use the loss(es) generated at block 525 to update the student model. As discussed above, this guides the student model to learn to perform more similarly to the expert model, as compared to some conventional solutions. Although a single iteration of updating the student model is depicted for conceptual clarity, in some aspects, the distillation system may perform multiple iterations of training the student model.

In these ways, as discussed above, the student diffusion model may learn to generate more accurate model output using fewer iterations, as compared to the expert model. Advantageously, using step distillation with sampling from both the student and the expert, the distillation system can significantly improve the quality of the student outputs while substantially reducing the computational resources consumed to generate such outputs.

### Example Method for Generating Output Using Diffusion Models

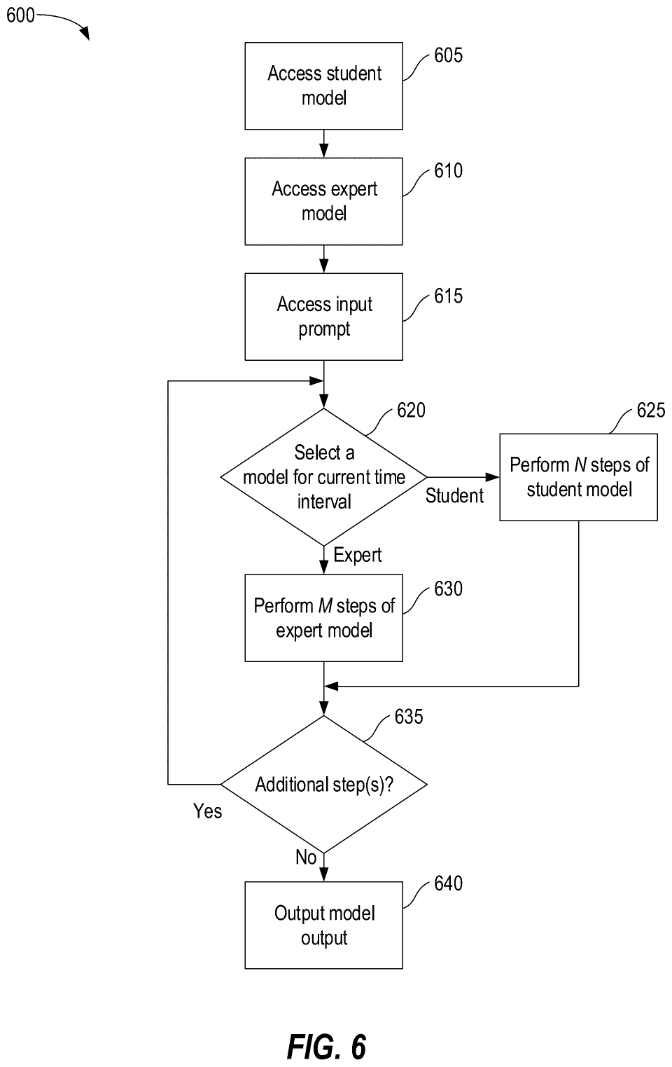

FIG. 6 is a flow diagram depicting an example method 600 for generating output using diffusion models, according to some aspects of the present disclosure. In some aspects, the method 600 is performed by a machine learning system, such as the machine learning system 135 of FIG. 1.

In some aspects, as discussed above, the machine learning system (or another computing system) may use the student model (e.g., the distilled diffusion model 115 of FIG. 1 and/or the student model 250 of FIG. 2) to generate data during runtime. In some aspects, rather than using solely the student model, the machine learning system may dynamically switch between the expert model and the diffusion model to generate output, as discussed above and below in more detail.

At block 605, the machine learning system accesses a student model (e.g., the distilled diffusion model 115 of FIG. 1 and/or the student model 250 of FIG. 2). Further, at block 610, the machine learning system accesses an expert model (e.g., the diffusion model 105 of FIG. 1 and/or the expert model 205 of FIG. 2). Although the illustrated example depicts the machine learning system accessing both the student model and the expert model, in some aspects, the machine learning system may access the student model locally (e.g., the student model may be stored or maintained locally by the machine learning system) and access the expert model remotely (e.g., the expert model may be stored or maintained remotely by another system, such as a cloud computing system). For example, to generate output using the student model, the machine learning system may use the local version of the mode. To generate output using the expert model, the machine learning system may transmit a request to the remote (e.g., cloud-based) system that offers access to the expert model.

At block 615, the machine learning system accesses an input prompt to be used to generate model output. For example, as discussed above, the prompt may comprise a textual string (e.g., describing the desired output), a sample image indicating the style or characteristics of the desired output, and the like.

At block 620, the machine learning system selects a model (e.g., either the expert model or the student model) to be used for the current time interval (e.g., the current iteration or step of output generation). Generally, the machine learning system may evaluate a variety of criteria or features to select the model. For example, in some aspects, the machine learning system may use a stochastic operation to select the model randomly. In some aspects, the machine learning system may use a biased stochastic operation (e.g., a stochastic operation that is biased towards either the expert or the student). For example, the machine learning system may be biased towards selecting the student model.

In some aspects, the machine learning system may evaluate the current output (e.g., the intermediate tensor, such as a processed image, if at least one iteration has already been performed) to select the next model for the next iteration. As an example, in some aspects, the machine learning system may determine whether the current output satisfies one or more quality criteria. For example, if the machine learning system determines that the current output does not satisfy a quality threshold (e.g., the quality of the output, which may be determined via a wide variety of image quality assessments, such as a structural similarity index (SSIM)), the machine learning system may determine to use the expert model for the next step.

As another example, the machine learning system may determine the differences between the current output and one or more previous outputs (e.g., intermediate processed images) that were generated by the expert model (e.g., from a prior time interval of the current trajectory, or from another trajectory). For example, if the current output differs above a threshold amount from the (prior) expert outputs, the machine learning system may determine to use the expert model for the next interval.

If, at block 620, the machine learning system selects the student model, the method 600 continues to block 625, where the machine learning system generates a next intermediate output (e.g., a next processed image) based on performing N steps of the student model, as discussed above. The method 600 then continues to block 635, discussed in more detail below.

Returning to block 620, if the machine learning system selects the expert model, the method 600 continues to block 630, where the machine learning system generates a next intermediate output (e.g., a next processed image) based on performing M steps of the expert model, as discussed above. In some aspects, the machine learning system may perform the M steps locally (e.g., using a local version of the expert model). In some aspects, as discussed above, the machine learning system may perform the M steps by providing the current intermediate output (or random noise, in the case of the first iteration) to a second system (e.g., a cloud-based system). This second system may then process the data using the expert model to generate the next output. The method 600 then continues to block 635.

At block 635, the machine learning system determines whether there is at least one additional step (e.g., at least on additional time interval) remaining in the data generation sequence. For example, as discussed above, the expert model may be configured to generate model output after M iterations, while the student model may be configured to generate output after N iterations. In some aspects, at block 635, the machine learning system may determine whether the equivalent of a full trajectory has been completed. For example, if the expert model is configured to generate output in A iterations and the student is configured to generate output in B iterations, the machine learning system may determine whether

$$a + b \frac{A}{B} = A ,$$

where a is the number of iterations completed (during the method 600) using the expert model and b is the number of iterations completed (during the method 600) using the student model.

If, at block 635, the machine learning system determines that at least one additional step remains to generate output, the method 600 returns to block 620. If the machine learning system determines that all iterations have been completed, the method 600 continues to block 640, where the machine learning system outputs the generated output data (e.g., to a user or other entity that requested the generation).

### Example Method for Diffusion Machine Learning

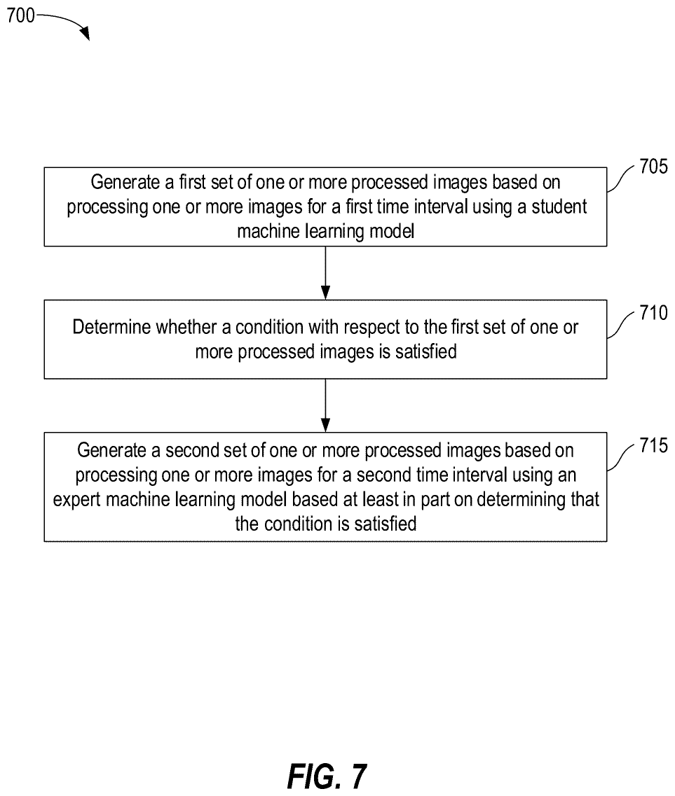

FIG. 7 is a flow diagram depicting an example method 700 for diffusion machine learning, according to some aspects of the present disclosure. In some aspects, the method 700 is performed by a distillation system and/or a machine learning system, such as the distillation system 110 and/or the machine learning system 135, each of FIG. 1, and/or the distillation systems and/or machine learning systems discussed above with reference to FIGS. 2-6.

At block 705, a first set of one or more processed images (e.g., the latents 220 of FIG. 2) is generated based on processing one or more images for a first time interval using a student machine learning model (e.g., the distilled diffusion model 115 of FIG. 1 and/or the student model 250 of FIG. 2).

At block 710, it is determined whether a condition with respect to the first set of one or more processed images is satisfied.

At block 715, a second set of one or more processed images is generated based on processing one or more images for a second time interval using an expert machine learning model (e.g., the diffusion model 105 of FIG. 1 and/or the expert model 205 of FIG. 2) based at least in part on determining that the condition is satisfied.

In some aspects, determining that the condition is satisfied comprises determining that the first set of one or more processed images do not satisfy a quality threshold.

In some aspects, the method 700 further includes generating the first set of one or more processed images using the student machine learning model and generate the second set of one or more processed images using the expert machine learning model based at least in part on a random selection between the expert machine learning model and the student machine learning model.

In some aspects, the random selection comprises a stochastic operation biased towards either the expert machine learning model or the student machine learning model.

In some aspects, determining that the condition is satisfied comprises determining that a difference between the first set of one or more processed images and one or more previous images generated using the expert machine learning model exceeds a threshold.

In some aspects, generating the second set of one or more processed images using the expert machine learning model is further based at least in part on a random selection between the expert machine learning model and the student machine learning model.

In some aspects, the random selection comprises a stochastic operation biased towards either the expert machine learning model or the student machine learning model.

In some aspects, parameters of the student machine learning model are loaded from the expert machine learning model. In some aspects, parameters of the student machine learning model are loaded from the expert machine learning model. In some aspects, the parameters of the student machine learning model are loaded from the expert model subsequent to initialization of the student machine learning model.

In some aspects, the expert machine learning model comprises a first diffusion model and uses a first number of iterations to generate model output, the student machine learning model comprises a distilled version of the expert machine learning model and uses a second number of iterations to generate model output, and the second number of iterations is smaller than the first number of iterations.

In some aspects, generating the first set of one or more processed images using the student machine learning model comprises perform a first number of iterations of the student machine learning model, and to generating the second set of one or more processed images using the expert machine learning model comprises causing the processing system to perform a second number of iterations of the expert machine learning model, wherein the second number of iterations is greater than the first number of iterations.

### Example Processing System for Machine Learning

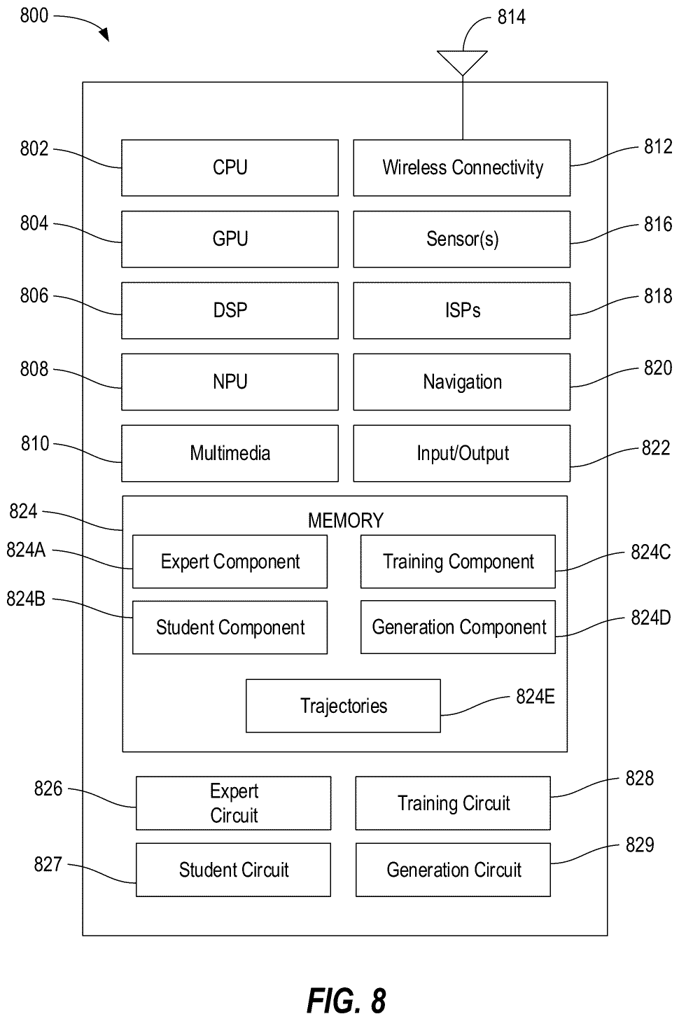

FIG. 8 depicts an example processing system 800 configured to perform various aspects of the present disclosure, including, for example, the techniques and methods described with respect to FIGS. 1-7. In some aspects, the processing system 800 may correspond to a machine learning system. For example, the processing system 800 may correspond to a distillation system and/or a machine learning system, such as the distillation system 110 and/or the machine learning system 135, each of FIG. 1, and/or the distillation systems and/or machine learning systems discussed above with reference to FIGS. 2-7. Although depicted as a single system for conceptual clarity, in some aspects, as discussed above, the components described below with respect to the processing system 800 may be distributed across any number of devices or systems.

The processing system 800 includes a central processing unit (CPU) 802, which in some examples may be a multi-core CPU. Instructions executed at the CPU 802 may be loaded, for example, from a program memory associated with the CPU 802 or may be loaded from a memory partition (e.g., a partition of a memory 824).

The processing system 800 also includes additional processing components tailored to specific functions, such as a graphics processing unit (GPU) 804, a digital signal processor (DSP) 806, a neural processing unit (NPU) 808, a multimedia component 810 (e.g., a multimedia processing unit), and a wireless connectivity component 812.

An NPU, such as the NPU 808, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 808 is a part of one or more of the CPU 802, the GPU 804, and/or the DSP 806.

In some examples, the wireless connectivity component 812 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 812 is further coupled to one or more antennas 814.

The processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS) as well as inertial positioning system components.

The processing system 800 may also include one or more input and/or output devices 822, such as screens, touch-sensitive surfaces (including touch-sensitive displays), physical buttons, speakers, microphones, and the like.

In some examples, one or more of the processors of the processing system 800 may be based on an ARM or RISC-V instruction set.

The processing system 800 also includes a memory 824, which is representative of one or more static and/or dynamic memories, such as a dynamic random access memory, a flash-based static memory, and the like. In this example, the memory 824 includes computer-executable components, which may be executed by one or more of the aforementioned processors of the processing system 800.

In particular, in this example, the memory 824 includes an expert component 824A, a student component 824B, a training component 824C, and a generation component 824D. Although not depicted in the illustrated example, the memory 824 may also include other components. Though depicted as discrete components for conceptual clarity in FIG. 8, the illustrated components (and others not depicted) may be collectively or individually implemented in various aspects.

As illustrated, the memory 824 also includes a set of trajectories 824E (e.g., sequences of model states and actions, as discussed above). For example, as discussed above, the trajectories 824E may include one or more expert trajectories (e.g., indicating the sequence of states for the expert model when generating output), one or more training trajectories (e.g., a sequence of states selected by a stochastic combination of the expert model and the student model), and the like. In some aspects, some or all of the trajectories 824E may include expert or target labels (e.g., the output of the expert model when one or more diffusion operations are applied, given all or a part of the trajectory), as discussed above.

The processing system 800 further comprises an expert circuit 826, a student circuit 827, a training circuit 828, and a generation circuit 829. The depicted circuits, and others not depicted, may be configured to perform various aspects of the techniques described herein.

The expert component 824A and/or the expert circuit 826 (which may correspond to the expert component 120 of FIG. 1 and/or use of diffusion model 105 of FIG. 1 and/or the expert model 205 of FIG. 2, as discussed above) may be used to perform diffusion-based generative machine learning, as discussed above. For example, the expert component 824A and/or the expert circuit 826 may generate output based on a sequence of iterations to iteratively generate the output guided by input text or other data.

The student component 824B and/or the student circuit 827 (which may correspond to the student component 125 of FIG. 1 and/or use of the distilled diffusion model 115 of FIG. 1 and/or the student model 250 of FIG. 2, as discussed above) may be used to perform diffusion-based generative machine learning using relatively fewer iterations or steps, as compared to the expert model, as discussed above. For example, the student component 824B and/or the student circuit 827 may be trained using step distillation to generate comparable output using fewer iterations.

The training component 824C and/or the training circuit 828 (which may correspond to the training component 130 of FIG. 1) may be used to generate trajectories and/or update the student model parameters, as discussed above. For example, the training component 824C and/or the training circuit 828 may use the expert model to generate expert trajectories, and use these expert trajectories to train the student model. The training component 824C and/or the training circuit 828 may then use the student model and the expert model to generate hybrid trajectories (including operations from each model), and may obtain expert feedback on these hybrid training trajectories. The training component 824C and/or the training circuit 828 may then use the feedback to further refine the student model, as discussed above in more detail.

The generation component 824D and/or the generation circuit 829 (which may correspond to the generation component 140 of FIG. 1) may be used to perform diffusion-based generative machine learning using the expert model and/or the trained student model, as discussed above. For example, the generation component 824D and/or the generation circuit 829 may select, for each iteration or time interval, whether to generate the next step using the expert model or the student model based on a variety of criteria such as the quality of the current output.

Though depicted as separate components and circuits for clarity in FIG. 8, the expert circuit 826, the student circuit 827, the training circuit 828, and the generation circuit 829 may collectively or individually be implemented in other processing devices of the processing system 800, such as within the CPU 802, the GPU 804, the DSP 806, the NPU 808, and the like.

Generally, the processing system 800 and/or components thereof may be configured to perform the methods described herein.

Notably, in other aspects, aspects of the processing system 800 may be omitted, such as where the processing system 800 is a server computer or the like. For example, the multimedia component 810, the wireless connectivity component 812, the sensor processing units 816, the ISPs 818, and/or the navigation processor 820 may be omitted in other aspects. Further, aspects of the processing system 800 maybe distributed between multiple devices.

### EXAMPLE CLAUSES

Implementation examples are described in the following numbered clauses:

Clause 1: A method, comprising: generating a first set of one or more processed images based on processing one or more images for a first time interval using a student machine learning model; determining whether a condition with respect to the first set of one or more processed images is satisfied; and generating a second set of one or more processed images based on processing one or more images for a second time interval using an expert machine learning model based at least in part on determining that the condition is satisfied.

Clause 2: A method according to Clause 1, wherein determining that the condition is satisfied comprises determining that the first set of one or more processed images does not satisfy a quality threshold.

Clause 3: A method according to Clause 2, wherein generating the second set of one or more processed images using the expert machine learning model is further based at least in part on a random selection between the expert machine learning model and the student machine learning model.

Clause 4: A method according to Clause 3, wherein the random selection comprises a stochastic operation biased towards either the expert machine learning model or the student machine learning model.

Clause 5: A method according to any of Clauses 1-4, wherein, determining that the condition is satisfied comprises determining that a difference between the first set of one or more processed images and one or more previous images generated using the expert machine learning model exceeds a threshold.

Clause 6: A method according to Clause 6, further comprising: generating the first set of one or more processed images using the student machine learning model and generating the second set of one or more processed images using the expert machine learning model based at least in part on a random selection between the expert machine learning model and the student machine learning model.

Clause 7: A method according to Clause 6, wherein the random selection comprises a stochastic operation biased towards either the expert machine learning model or the student machine learning model.

Clause 8: A method according to any of Clauses 1-7, wherein parameters of the student machine learning model are loaded from the expert machine learning model.

Clause 9: A method according to Clause 8, wherein the parameters of the student machine learning model are loaded from the expert machine learning model during initialization of the student machine learning model.

Clause 10: A method according to Clause 9, wherein the parameters of the student machine learning model are loaded from the expert model subsequent to initialization of the student machine learning model.

Clause 11: A method according to any of Clauses 1-9, wherein: the expert machine learning model comprises a first diffusion model and uses a first number of iterations to generate model output, the student machine learning model comprises a distilled version of the expert machine learning model and uses a second number of iterations to generate model output, and the second number of iterations is smaller than the first number of iterations.

Clause 12: A method according to any of Clauses 1-9, wherein: generating the first set of one or more processed images using the student machine learning model comprises performing a first number of iterations of the student machine learning model, generating the second set of one or more processed images using the expert machine learning model comprising perform a second number of iterations of the expert machine learning model, and the second number of iterations is greater than the first number of iterations.

Clause 13: A method, comprising: accessing a first diffusion model; generating a first set of trajectories using the first diffusion model; obtaining an output of a second diffusion model based on the first set of trajectories; generating a second set of trajectories based on, for each respective time step of a plurality of time steps: selecting either the first diffusion model or the second diffusion model; generating a respective output using the selected model; and updating the second set of trajectories based on the respective output; generating a third set of trajectories based on the second set of trajectories and using the first diffusion model; and obtaining a new output of the second diffusion model based on the third set of trajectories.

Clause 14: A method according to Clause 13, wherein obtaining the output of the second diffusion model based on the first set of trajectories comprises training the second diffusion model based on the first set of trajectories.

Clause 15: A method according to any of Clauses 13-14, wherein selecting either the first diffusion model or the second diffusion model is performed using a stochastic operation.

Clause 16: A method according to Clause 15, wherein the stochastic operation is biased towards either the first diffusion model or the second diffusion model based on a training stage of the second diffusion model.

Clause 17: A method according to Clause 16, wherein: during a first training stage of the second diffusion model, the stochastic operation is biased towards the first diffusion model, as compared to the second diffusion model; and during a second training stage of the second diffusion model subsequent to the first training stage, the stochastic operation is biased towards the second diffusion model, as compared to the first diffusion model.

Clause 18: A method according to any of Clauses 13-17, wherein generating the third set of trajectories comprises: selecting a time step of the plurality of time steps; processing a first state corresponding to the selected time step, from at least one trajectory of the second set of trajectories using the first diffusion model to generate a label; and adding the label to the third set of trajectories.

Clause 19: A method according to any of Clauses 13-18, wherein obtaining the new output of the second diffusion model based on the third set of trajectories comprises training the second diffusion model based on the third set of trajectories.

Clause 20: A method according to any of Clauses 13-19, wherein each respective trajectory of the first set of trajectories comprises a respective sequence of states of the first diffusion model to generate model output.

Clause 21: A method according to any of Clauses 13-20, wherein: the first diffusion model uses a first number of iterations to generate model output, the second diffusion model comprises a distilled version of the first diffusion model and uses a second number of iterations to generate model output, and the second number of iterations is smaller than the first number of iterations.

Clause 22: A method according to any of Clauses 13-21, wherein generating the respective output using the selected model comprises: if the first diffusion model is selected, performing a first number of iterations of the first diffusion model, and if the second diffusion model is selected, performing a second number of iterations of the second diffusion model, wherein the second number of iterations is smaller than the first number of iterations.

Clause 23: A method according to any of Clauses 13-22, further comprising providing the second diffusion model, using a modem, to a computing device.

Clause 24: A processing system comprising means for performing a method in accordance with any of Clauses 1-23.

Clause 25: A non-transitory computer-readable medium comprising computer-executable instructions that, when executed by one or more processors of a processing system, cause the processing system to perform a method in accordance with any of Clauses 1-23.

Clause 26: A computer program product embodied on a computer-readable storage medium comprising code for performing a method in accordance with any of Clauses 1-23.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system in a device, comprising:
one or more memories comprising processor-executable instructions; and
one or more processors coupled to the one or more memories and configured to execute the processor-executable instructions and cause the processing system to:
generate a first set of one or more processed images based on processing one or more images for a first time interval using a student machine learning model;
determine whether a condition with respect to the first set of one or more processed images is satisfied; and
generate a second set of one or more processed images based on processing one or more images for a second time interval using an expert machine learning model based at least in part on determining that the condition is satisfied.

2. The processing system of claim 1, wherein, to determine that the condition is satisfied, the one or more processors are configured to execute the processor-executable instructions and cause the processing system to determine that the first set of one or more processed images does not satisfy a quality threshold.

3. The processing system of claim 2, wherein generation of the second set of one or more processed images using the expert machine learning model is further based at least in part on a random selection between the expert machine learning model and the student machine learning model.

4. The processing system of claim 3, wherein the random selection comprises a stochastic operation biased towards either the expert machine learning model or the student machine learning model.

5. The processing system of claim 1, wherein, to determine that the condition is satisfied, the one or more processors are configured to execute the processor-executable instructions and cause the processing system to determine that a difference between the first set of one or more processed images and one or more previous images generated using the expert machine learning model exceeds a threshold.

6. The processing system of claim 5, wherein the one or more processors are configured to execute the processor-executable instructions and further cause the processing system to generate the first set of one or more processed images using the student machine learning model and generate the second set of one or more processed images using the expert machine learning model based at least in part on a random selection between the expert machine learning model and the student machine learning model.

7. The processing system of claim 6, wherein the random selection comprises a stochastic operation biased towards either the expert machine learning model or the student machine learning model.

8. The processing system of claim 1, wherein parameters of the student machine learning model are loaded from the expert machine learning model.

9. The processing system of claim 8, wherein the parameters of the student machine learning model are loaded from the expert machine learning model during initialization of the student machine learning model.

10. The processing system of claim 8, wherein the parameters of the student machine learning model are loaded from the expert model subsequent to initialization of the student machine learning model.

11. The processing system of claim 1, wherein:
the expert machine learning model comprises a first diffusion model and uses a first number of iterations to generate model output,
the student machine learning model comprises a distilled version of the expert machine learning model and uses a second number of iterations to generate model output, and
the second number of iterations is smaller than the first number of iterations.

12. The processing system of claim 1, wherein:
to generate the first set of one or more processed images using the student machine learning model, the one or more processors are configured to execute the processor-executable instructions and cause the processing system to perform a first number of iterations of the student machine learning model;
to generate the second set of one or more processed images using the expert machine learning model, the one or more processors are configured to execute the processor-executable instructions and cause the processing system to perform a second number of iterations of the expert machine learning model; and
the second number of iterations is greater than the first number of iterations.

13. A processor-implemented method for machine learning, comprising:
generating a first set of one or more processed images based on processing one or more images for a first time interval using a student machine learning model;
determining whether a condition with respect to the first set of one or more processed images is satisfied; and
generating a second set of one or more processed images based on processing one or more images for a second time interval using an expert machine learning model based at least in part on determining that the condition is satisfied.

14. The processor-implemented method of claim 13, wherein, determining that the condition is satisfied comprises determining that the first set of one or more processed images does not satisfy a quality threshold.

15. The processor-implemented method of claim 13, wherein generating the second set of one or more processed images using the expert machine learning model is further based at least in part on a random selection between the expert machine learning model and the student machine learning model.

16. The processor-implemented method of claim 14, wherein the random selection comprises a stochastic operation biased towards either the expert machine learning model or the student machine learning model.

17. The processor-implemented method of claim 13, wherein determining that the condition is satisfied comprises determining that a difference between the first set of one or more processed images and one or more previous images generated using the expert machine learning model exceeds a threshold.

18. The processor-implemented method of claim 13, wherein:
the expert machine learning model comprises a first diffusion model and uses a first number of iterations to generate model output,
the student machine learning model comprises a distilled version of the expert machine learning model and uses a second number of iterations to generate model output, and
the second number of iterations is smaller than the first number of iterations.

19. The processor-implemented method of claim 13, wherein:
generating the first set of one or more processed images using the student machine learning model comprises performing a first number of iterations of the student machine learning model,
generating the second set of one or more processed images using the expert machine learning model comprises performing a second number of iterations of the expert machine learning model, and
the second number of iterations is greater than the first number of iterations.

20. A processing system, comprising:
means for generating a first set of one or more processed images based on processing one or more images for a first time interval using a student machine learning model;
means for determining whether a condition with respect to the first set of one or more processed images is satisfied; and
means for generating a second set of one or more processed images based on processing one or more images for a second time interval using an expert machine learning model based at least in part on determining that the condition is satisfied.
